(19) United States
(12) Patent Application Publication
(10) Pub. No.: US 2019/0172598 A1
(43) Pub. Date: Jun. 6, 2019

(54) ASTEROID MINING SYSTEMS FACILITATED BY COSMIC RAY AND MUON-CATALYZED FUSION

(71) Applicant: Jerome Drexler, Los Altos Hills, CA (US)

(72) Inventor: Jerome Drexler, Los Altos Hills, CA (US)

(21) Appl. No.: 15/832,498

(22) Filed: Dec. 5, 2017

(51) Int. Cl. G21D 7/00; F03D 9/25; B64G 1/40; B64G 99/00; G21H 7/00; G21D 1/02; G21B 1/11; G21B 1/19

(52) U.S. Cl. CPC G21D 7/00; F03D 9/25; B64G 1/405; B64G 9/00; E21C 51/00; G21D 1/02; G21B 1/11; G21B 1/19; G21H 7/00

(57) ABSTRACT

Cosmic ray and muon-catalyzed micro-fusion electrical generation provides electrical power for mining operations, including any asteroid habitats and mining equipment. The micro-fusion generator systems deploy deuterium-containing fuel material as a localized cloud interacting with incoming ambient cosmic rays to generate energetic fusion products. Dust or other particulate matter in the fuel material, in the localized cloud, and in the space surrounding the asteroid being mined converts some cosmic rays into muons that also catalyze fusion. The fusion products drive turbines to facilitate the electrical generation.

### TECHNICAL FIELD

The present invention relates to space systems that provide energy for asteroid mining operations in space (or on a lunar or planetary surface).

### BACKGROUND ART

Many asteroids are rich in valuable elements that are either relatively rare in the Earth's crust or whose terrestrial reserves are becoming increasingly scarce due to overconsumption (e.g., the platinum-group metals, as well as nickel and cobalt). By one estimate, a 100 m diameter M-type asteroid may contain $50 billion worth of platinum. Additionally, many other asteroids comprise raw materials for space-based construction or as a source of extractable water and oxygen useful for sustaining manned deep space operations.

Methods are being explored for redirecting small asteroids (less than 100 m diameter) into a new orbit to exploit its mineral resources more conveniently. Redirection techniques being explored generally divide into those that provide a large, but short-lived, impulse to the asteroid (e.g. by explosive or kinetic impact) and others that provide a slow, but sustained, push (whether by ablation of asteroid material with focused solar energy or a pulsed laser, ejecting of mined asteroid material at high velocity, by attachment to the asteroid and giving a direct tug or push, or by a gravity tractor flying in close proximity). Because of the greater velocity change needed for redirecting an asteroid to a more convenient location for mining, the methods being explored would be limited at this time to asteroids smaller than about 20 m in diameter and with a mass not more than 10⁷ kg. Improvements in propulsion systems could eventually allow asteroids smaller than 100 m diameter and 10⁹ kg mass to be successfully redirected. Even moving a relatively small asteroid would require that one burn rocket engines longer than usual for most spaceflights to achieve a desired change in velocity. But this consumes significant amounts of fuel and isn't feasible with current rocket technology. Likewise, to provide a constant acceleration from thrust would require that rocket engines burn constantly over the entire flight, leading to even greater fuel usage. Even when using a standard accelerate-coast-decelerate trajectory, an asteroid's heavy mass calls for a significant penalty in fuel if using chemical rocket engines. Current cost estimates for redirecting an asteroid with existing chemical rocket technology begin at several billion dollars.

Larger asteroids would need to be mined on site and the mined material then transported off the asteroid to its destination. This requires one to go the asteroid, either with a mining crew or with automated mining equipment or both. Advancing of propulsion technologies would improve the efficiency of trips and shorten travel time to and from an asteroid, reduce consumables and mass of materials required for the journey, and (if manned) reduce astronaut health risks from both weightlessness and radiation exposure. But asteroid mining at the source also requires an efficient power source for sustaining mining operations, including running the equipment.

Sustained investments in fundamental research and early-stage innovation in technologies is required to meet asteroid mining goals. Such research and development activity is expected to proceed in several general stages, beginning with an Earth-reliant stage with research and testing on the ISS of concepts and systems that could enable deep space, long-duration crewed missions, followed by a proving ground stage in cis-lunar space to test and validate complex operations and components before moving on to largely Earth-independent stages. Such a proving ground stage would field one or more in-space propulsion systems capable of performing the desired task of reaching a selected asteroid in “near-Earth” orbit to undergo a series of shakedown tests to demonstrate their capabilities, select a final architecture, and make needed upgrades revealed by the shakedown tests. While systems already in development for the initial Earth-reliant missions largely make use of existing technologies, investment in the development of newer technologies will be needed to meet the longer-term deep space challenges.

Muon-catalyzed fusion was observed by chance in late 1956 by Luis. Alvarez and colleagues during evaluation of liquid-hydrogen bubble chamber images as part of accelerator-based particle decay studies. These were rare proton-deuteron fusion events that only occurred because of the natural presence of a tiny amount of deuterium (one part per 6000) in the liquid hydrogen. It was quickly recognized that fusion many orders of magnitude larger would occur with either pure deuterium or a deuterium-tritium mixture. However, John D. Jackson (Lawrence Berkeley Laboratory and Prof. Emeritus of Physics, Univ. of California, Berkeley) correctly noted that for useful power production there would need to be an energetically cheap way of producing muons. The energy expense of generating muons artificially in particle accelerators combined with their short lifetimes has limited its viability as an Earth-based fusion source, since it falls short of break-even potential.

Another controlled fusion technique is particle-target fusion which comes from accelerating a particle to sufficient energy so as to overcome the Coulomb barrier and interact with target nuclei. To date, proposals in this area depend upon using some kind of particle accelerator. Although some fusion events can be observed with as little as 10 KeV acceleration, fusion cross-sections are sufficiently low that accelerator-based particle-target fusion are inefficient and fall short of break-even potential.

It is known that cosmic rays are abundant in interplanetary space. Cosmic rays are mainly high-energy protons (with some high-energy helium nuclei as well) with kinetic energies in excess of 300 MeV. Most cosmic rays have GeV energy levels, although some extremely energetic ones can exceed 10¹⁸ eV. FIG. 5 shows cosmic ray flux distribution at the Earth's surface. In near-Earth space, the alpha magnetic spectrometer (AMS-02) instrument aboard the International Space Station since 2011 has recorded an average of 45 million fast cosmic ray particles daily (approx. 500 per second). The overall flux of galactic cosmic ray protons (above earth's atmosphere) can range from a minimum of 1200 m⁻² s⁻¹ sr⁻¹ to as much as twice that amount. (The flux of galactic cosmic rays entering our solar system, while generally steady, has been observed to vary by a factor of about 2 over an 11-year cycle according to the magnetic strength of the heliosphere.) Outside of Earth's protective magnetic field (e.g. in interplanetary space), the cosmic ray flux is expected to be several orders of magnitude greater. As measured by the Martian Radiation Experiment (MARIE) aboard the Mars Odyssey spacecraft, average in-orbit cosmic ray doses were about 400-500 mSv per year, which is an order of magnitude higher than on Earth.

Cosmic rays are known to generate abundant muons from the decay of cosmic rays passing through Earth's atmosphere. Cosmic rays lose energy upon collisions with atmospheric dust, and to a lesser extent atoms or molecules, generating elementary particles, including pions and then muons, usually within a penetration distance of a few cm. Typically, hundreds of muons are generated per cosmic ray particle from successive collisions. Near sea level on Earth, the flux of muons generated by the cosmic rays' interaction by the atmosphere averages about 70 m⁻² s⁻¹ sr⁻¹. The muon flux is even higher in the upper atmosphere. These relatively low flux levels on Earth reflect the fact that both Earth's atmosphere and geomagnetic field substantially shields our planet from cosmic ray radiation. Mars is a different story, having very little atmosphere (only 0.6% of Earth's pressure) and no magnetic field, so that muon generation at Mars' surface is expected to be very much higher than on Earth's surface. Planetary moons, such as Phobos and Deimos around Mars, would experience similar high levels of cosmic ray flux.

### SUMMARY DISCLOSURE

The present invention is a method and system of providing electrical power to sustain mining operations that takes advantage of the abundance of cosmic rays available for free in interplanetary space and the abundance of muons generated on Mars or other planets (or their moons) with a thin (or no) atmosphere and weak (or no) magnetic field to catalyze sufficient fusion. Micro-fusion electric generators can be used to power both habitats for astronaut miners on larger asteroids and to power mining equipment on asteroids of all sizes. Note that the cosmic rays and muons are available here for free and do not need to be generated artificially in an accelerator. Since the amount of energy needed is generally much less than the multi-kiloton yields of atomic weapons, “micro-fusion” is the term used here to refer to fusion energy outputs of not more than 10 gigajoules per second (2.5 tons of TNT equivalent per second), to thereby exclude macro-fusion type explosions.

An electrical generation apparatus for asteroid mining activity can be provided that employs a muon-catalyzed controlled nuclear micro-fusion method to create a “wind” of large numbers of high-energy helium nuclei to drive a set of turbines. These “helium-wind” turbines are mechanically connected to a corresponding number of induction generators to produce electricity. A cloud of micro-fusion target material is suspended within a reaction chamber and is bombarded with incoming cosmic rays and muons arriving through the top of the chamber. The micro-fusion target material will then interact with the ambient flux of cosmic rays and muons producing a combination of particle-target micro-fusion and/or muon-catalyzed micro-fusion, generating kinetic-energy-containing fusion products. Turbines arranged around the reaction chamber can be driven by the energetic products, such as alpha particles, in order to create electricity. Such generators could also be used to power ion thrusters for propelling mined asteroid material back to earth.

The “fuel” for the particle-target and/or muon-catalyzed micro-fusion may be supplied in the form of solid Li⁶D as chips, pellets or powder, or even heavy water (D₂O) or liquid deuterium (D₂). To assist muon formation, the fuel packages may contain up to 20% by weight of added particles of fine sand or dust. Muon-created muonic deuterium can come much closer to the nucleus of a similar neighboring atom with a probability of fusing deuterium nuclei, releasing energy. Once a muonic molecule is formed, fusion proceeds extremely rapidly (˜10⁻¹⁰ sec). One cosmic ray particle can generate hundreds of muons, and each muon can typically catalyze about 100 micro-fusion reactions before it decays (the exact number depending on the muon “sticking” cross-section to any helium fusion products).

Other types of micro-fusion reactions besides D-D are also possible depending upon the target material. For example, another reaction is Li⁶+D→2He⁴+22.4 MeV, where much of the useful excess energy is carried as kinetic energy of the two helium nuclei (alpha particles). Additionally, any remaining cosmic rays can themselves directly stimulate micro-fusion events by particle-target fusion, wherein the. high energy cosmic ray particles (mostly protons, but also helium nuclei) bombard relatively stationary target material. When bombarded directly with cosmic rays, the lithium-6 may be transmuted into tritium which could form the basis for some D-T micro-fusion reactions. Although D-D micro-fusion reactions occur at a rate only 1% of D-T micro-fusion, and produce only 20% of the energy by comparison, the freely available flux of cosmic rays and their generated muons should be sufficient to yield sufficient micro-fusion energy output for practical use.

The present invention achieves nuclear micro-fusion using deuterium-containing target material, and the ambient flux of cosmic rays and generated muons that are already naturally present. The optimum concentration of the target material for the particle-target and muon-catalyzed fusion may be determined experimentally based on the particular abundance of cosmic rays with a view to maintaining billions of micro-fusion reactions for producing adequate electrical generation for the specified applications, while avoiding any possibility of a runaway macro-fusion event.

At a minimum, since both particle-target micro-fusion and muon-catalyzed micro-fusion, while recognized, are still experimentally immature technologies (since measurements have only been conducted to date on Earth using artificially accelerated particles and generated muons from particle accelerators), various embodiments of the present invention can have research utility to demonstrate feasibility in environments beyond Earth's protective atmosphere and/or geomagnetic field, initially above Earth's atmosphere (e.g. on satellite platforms) for trial purposes, and then on the Moon or in lunar orbit before further testing at a near-Earth orbit (NEO) asteroid, to determine optimum parameters for various utilities in those environments. For example, the actual number of micro-fusion reactions for various types of fusion fuel sources and target configurations, and the amount of electrical output that can be derived from such reactions, are still unknown and need to be fully quantified in order to improve the technology. The fusion-enhanced propulsion system requires strong cosmic ray flux to create sufficient nuclear micro-fusion, and therefore is best suited to operation in deep space environments, such as in proximity to asteroids.

### BRIEF DESCRIPTION OF THE DRAWINGS

FIG. 1 is a schematic plan view of a micro-fusion-driven turbine generator apparatus in accord with the present invention, shown operating on the surface of an asteroid to supply electrical power.

FIG. 2 is a schematic side view of a micro-fusion-driven turbine generator as in FIG. 1 supplying electricity to asteroid mining habitats.

FIG. 3 is a top plan view of the reaction volume of the turbine generator apparatus as in FIG. 1 showing an arrangement of turbines and generators circumferentially around a reaction volume.

FIG. 4 is a side plan view of the reaction volume of a turbine generator apparatus as in FIG. 1 showing the turbines and generators in a vertically stacked arrangement along a length of the reaction volume.

FIG. 5 is a graph of cosmic ray flux at the Earth surface versus cosmic ray energy, after very significant cosmic ray absorption by Earth's atmosphere has occurred.

### DETAILED DESCRIPTION

Cosmic-ray and muon-catalyzed micro-fusion can be employed in the invention to supply electrical power for mining of asteroids (either by automated mining equipment transported to the asteroid, or with assistance of astronaut-miners) and the mined products returned to Earth. Cosmic ray flux naturally present in interstellar space is used to power nuclear micro-fusion events (via particle-target micro-fusion and muon-catalyzed micro-fusion) that will generate electrical energy for the mining activity.

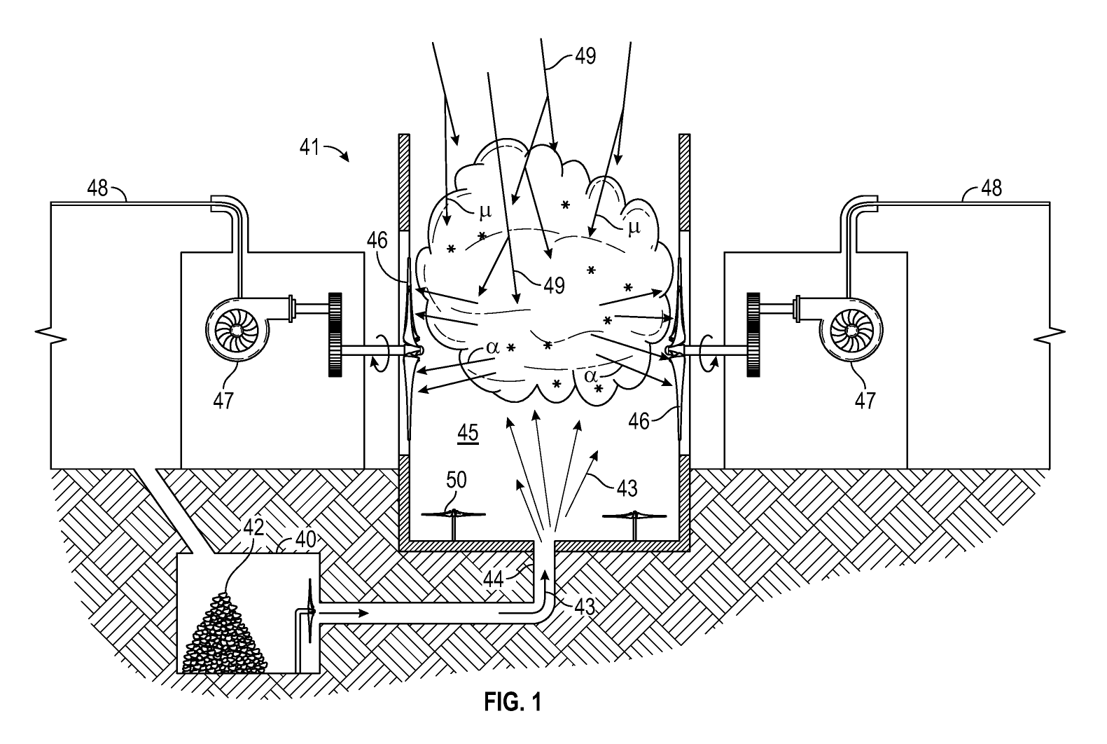

In the embodiment shown in FIG. 1, each engine may have one or more turbine electric generators 41, where the turbines are driven by the fast helium nuclei micro-fusion products generated from dispersed lithium-6 deuteride or other deuterium-containing micro-fusion target material exposed to the cosmic rays. Micro-fusion fuel packages would be delivered to the vicinity of each of the turbines, where the micro-fusion reaction products can turn the turbines to generate electricity for asteroid mining, including powering of mining equipment and powering of ion thrusters to move or redirect asteroids with mining potential. For example, in one embodiment a cloud of deuterium-containing micro-fusion target fuel 43, e.g. particles of Li⁶D, is dispersed from a flue 44 into a volume 45 between two or more helium-wind turbines 46. Specifically, a generator assembly 41 includes a source 40 of deuterium-containing micro-fusion particle fuel material 42. This material could be blown 43 through a flue 44 (e.g. by means of a fan with a gas source at the source 40 or by other means depending on the form that the fuel material takes), and then dispersed from the flue 44 into a reaction volume 45.

The micro-fusion target fuel material 43 is dispersed in proximity to turbines 46 arranged around the reaction volume 45, and then exposed to ambient cosmic rays 49 and muons μ that enters the volume 45 and interacts with the dispersed fuel material 43 to cause nuclear micro-fusion events. High-energy cosmic rays 49 entering the volume 45 interact with the micro-fusion target fuel material 43 to cause nuclear fusion events. Fusion products, mainly high energy helium nuclei (alpha particles), direct kinetic energy to the turbine blades 46 to turn the turbines and generate electricity. A “wind” of micro-fusion products made up of energetic helium (alpha products) impinge upon and direct kinetic energy to the turbine blades 46 to turn the turbines and drive the associated generators 47 to produce electricity which can then be supplied via electric cables 48 to the habitats and other equipment. A set of one or more fans 50 in the reaction volume 45 may help keep the fuel material in suspension near the turbines 46.

The micro-fusion electrical generator system works in the presence of an ambient flux of cosmic rays and/or muons which interact with the cloud and trigger the nuclear micro-fusion of the particle target material, either by particle-target micro-fusion or muon-catalyzed micro-fusion or both. The micro-fusion fuel releases as a cloud and can be solid Li⁶D in powder form, D-D or D-T inertial-confinement-fusion-type pellets, D₂O ice crystals, or droplets of (initially liquid) D₂.

The deuterium “fuel” for a generator may be supplied in the form of clouds of solid lithium-6 deuteride powder, pellets or chips, or even frozen heavy water (D₂O) or liquid droplets of D₂, to a reaction chamber 45, where it is exposed to incoming cosmic rays 49 and muons i, as seen in FIG. 1. One technique for creating the cloud of fusion target material is to shoot “fuel” packages as a series of projectiles into the reaction chamber, which can then disperse the fusion material as a localized cloud, much like fireworks or artillery. For this purpose, one or more gun tubes may be located below the chamber and loaded with the packages for introduction into the chamber. Alternatively, packages may be “dropped” into the chamber from near the top via a slide dispenser. The fuel within the projectile packages can be solid Li⁶D in powder form, D-D or D-T inertial-confinement-fusion-type pellets, or D₂O ice crystals. To assist muon formation, especially when D₂O is used, the target package may contain up to 20% by weight of added particles of fine sand or dust. Packages will be shielded, at least within the casing of the projectiles themselves, to reduce or eliminate premature fusion events until delivered and dispersed as a cloud in the reaction chamber. Soon after the projectile has reached the desired dispersal location within the chamber, the package releases its target material. For example, a chemical explosion can be used to locally disperse the fusion material. For a typical cloud of Li⁶D in powder form it may be desired to disperse the material near the top of the chamber to allow maximum usage of the material while it settles toward the bottom of the chamber. In the case of very large asteroids, it might be advantageous to provide one or more fans 50 at the bottom of the chamber 45 (seen in FIG. 1) to keep the cloud of target material suspended in the chamber as long as possible, but most asteroids will have sufficiently low, even negligible, gravity so that the micro-fusion fuel material settling too rapidly would not be a concern.

The dispersed cloud of target material will be exposed to both cosmic rays and to their generated muons. To assist in the formation of muons for muon-catalyzed fusion, especially when D₂O or D₂ is used, the target package may contain up to 20% by weight of added particles of fine sand or dust. As cosmic rays collide with both micro-fusion target material and dust, they form muons that are captured by the deuterium and that catalyze micro-fusion. Likewise, the cosmic ray collisions themselves can directly trigger particle-target micro-fusion. Fusion products having significant kinetic energy (e.g. alpha particles) are generated and are received by turbines.

Besides D-D micro-fusion reactions, other types of micro-fusion reactions may also occur (e.g. D-T, using tritium generated by cosmic rays impacting the lithium-6; as well as Li⁶-D reactions from direct cosmic ray collisions). For this latter reaction, it should be noted that naturally occurring lithium can have an isotopic composition ranging anywhere from as little as 1.899% to about 7.794% Li⁶, with most samples falling around 7.4% to 7.6% Li⁶. Although LiD that has been made from natural lithium sources could also be used, fuel material that has been enriched with greater proportions of Li⁶ is preferable for achieving greater efficiency.

Stored fuel packages associated with the attached generator will be shielded to reduce or eliminate premature fusion events until delivered and dispersed as a cloud in the chamber. Some small amount of metal for fuel storage unit could be used for shielding, if needed. (For example, the Juno spacecraft to Jupiter contains radiation vaults of 1 cm thick titanium to shield its electronics from external radiation. A similar type of vault might be used in this case for the shielding of the stored fuel.) Alternatively, another possible source of such shielding might include the astronaut-miners' own water supply (if part of a manned mission), which should be adequate for the task. One need not eliminate cosmic rays or their secondary particles (pions, muons, etc.) to zero, but merely reduce their numbers and energies sufficiently to keep them from catalyzing sufficiently large numbers of fusion events in the stored target particle material.

The rate of fuel usage will depend on the amount of electricity required, the amount of fusion obtained from the ambient cosmic ray and/or muon flux, the dispersal rate of the fuel cloud from the chamber and the efficiency of the transfer of the fusion products into turbine rotation. Assuming most of the energy can be captured, an estimated 10¹⁵ individual micro-fusion reactions (less than 1 μg of fuel consumed) per second would be required for 1 kW output. But as each cosmic ray can create hundreds of muons and each muon can catalyze 100 micro-fusion reactions, the available cosmic ray flux in interplanetary space is believed to be sufficient for this purpose following research, development, and engineering efforts.

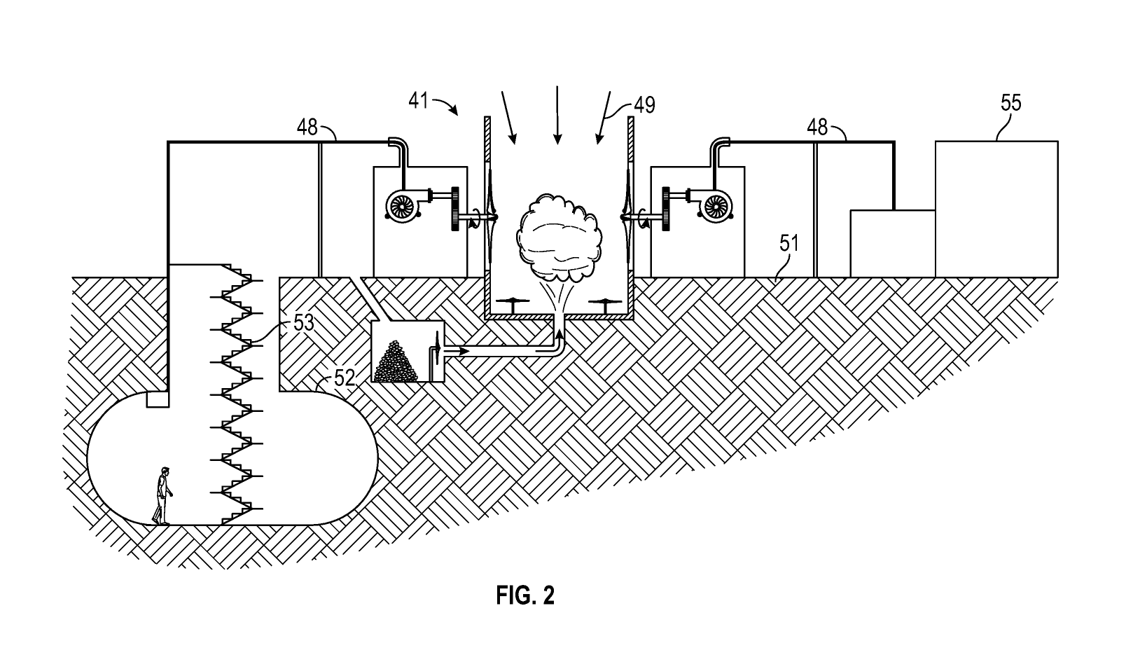

For very large asteroids (i.e. dwarf planets or slightly smaller) that cannot be redirected but must be mined in their current location, FIG. 2 shows the turbine electric generator apparatus 41 located on the asteroid surface 11, where the generators are powered by reaction of ambient cosmic rays and muons with a dispersed cloud of micro-fusion fuel within a reaction volume of the apparatus 41. Electrical power lines 48 lead from the generator apparatus 41 to various mining habitats for manned mining missions. Some habitats (depending on the composition of the asteroid) might be underground, as in habitat 52, which might be accessible via a stairwell 53. Electrical power lines 48 could feed electricity to the habitat 52 via conduits along the same access column that supports the stairwell. Other habitats might be above ground, as in habitat 55, powered by electricity supplied via external power lines 48. If the asteroid is too small for habitation, the astronaut abode is their spacecraft, while the generator apparatus still supports mining operations by providing electrical power for the mining equipment. In accord with the invention, the generator apparatus 41 has turbines driven by fast helium nuclei micro-fusion products generated from dispersed lithium-6 deuteride or other deuterium-containing micro-fusion target material exposed to the cosmic rays and muons.

As seen in FIGS. 1 and 2, the chamber may be arranged with its cylindrical or columnar axis pointing in a vertical direction, since cosmic rays and generated muons will be arriving from above, and the asteroid itself will shield in-coming cosmic rays from below, such that the chamber should be located and pointed in a direction that maximizes receipt of cosmic rays onto the cloud of fusion target material within the chamber.

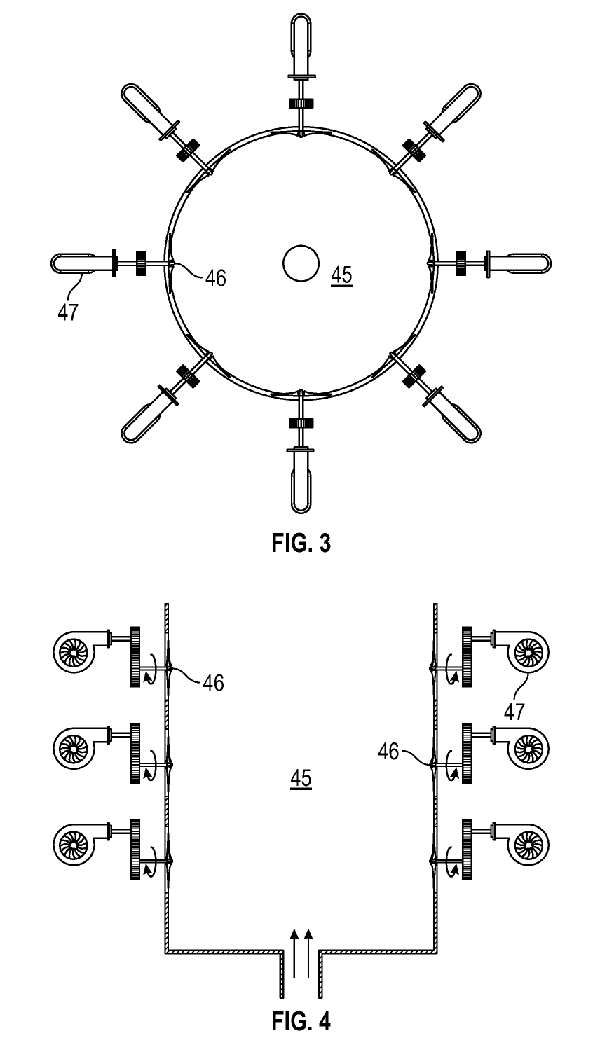

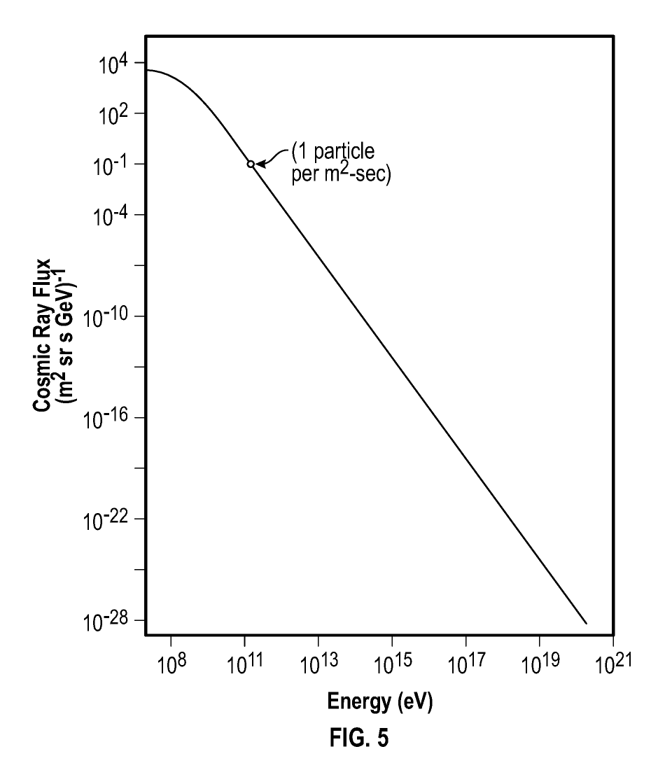

As seen in FIG. 3, the turbines 46 may be arranged around the circumference of the reaction volume 45, which can be cylindrical or any other equivalent columnar shape. While typically four in number, there can anywhere from as few as two up to 20 or more such turbines 46 (eight are seen here), depending on the space available, the size of the fusion reaction cloud, and the size and arrangement of the turbines themselves about the chamber 45. Alternatively, or in addition, as seen in FIG. 4, the turbines 46 may be arranged in multiple stacks along the length of the cylindrical reaction volume 45. Turbines are connected, e.g. through gearboxes, to corresponding induction generators 47. The generators 47 may be equal in number to the corresponding turbines 46 (1:1 correspondence), or multiple turbines may drive any given generator (n:1 correspondence).

The present invention achieves nuclear micro-fusion using deuterium-containing target material, and the ambient flux of cosmic rays and generated muons that are already naturally present. The dispersed cloud of target material will be exposed to both cosmic rays and to their generated muons. As cosmic rays collide with fusion targets and dust, they form muons that are captured by the deuterium and that catalyze fusion. Likewise, the cosmic ray collisions themselves can directly trigger particle-target fusion. Muonic deuterium, tritium or lithium-6 can come much closer to the nucleus of a similar neighboring atom with a probability of fusing deuterium nuclei, releasing energy. Once a muonic molecule is formed, fusion proceeds extremely rapidly (on the order of 10⁻¹⁰ sec). One cosmic ray particle can generate hundreds of muons, and each muon can typically catalyze about 100 fusion reactions before it decays (the exact number depending on the muon “sticking” cross-section to any helium fusion products). For example, a particularly desired reaction is Li⁶+D→2He⁴+22.4 MeV, where much of the useful excess energy is carried as kinetic energy of the two helium nuclei (alpha particles). The alpha particles then provide a motive force to turbine blades for the generation of electricity. Other fusion reactions also create. energetic fusion products that can drive the turbines.

Additionally, any remaining cosmic rays can themselves directly stimulate a fusion event by particle-target fusion, wherein the high energy cosmic ray particles (mostly protons, but also helium nuclei) bombard the cloud of target material. When bombarded directly with cosmic rays, the lithium may be transmuted into tritium which could form the basis for some D-T fusion reactions. Although D-D fusion reactions occur at a rate only 1% of D-T fusion, and produce only 20% of the energy by comparison, the freely available flux of cosmic rays and their generated muons should be sufficient to yield sufficient fusion energy output for practical use.

The optimum concentration of the cloud of target material for the particle-target and muon-catalyzed fusion may be determined experimentally based on the particular abundance of cosmic rays with a view to maintaining a chain reaction of fusion events for producing adequate thrust against the turbine blades, while avoiding any possibility of runaway fusion.

The present invention achieves muon-catalyzed nuclear fusion using deuterium-containing target material, and muons that are naturally created from ambient cosmic rays. Most cosmic rays are energetic enough to create multiple muons (often several hundred) by successive collisions with dust or with the atoms in a target. In fact, most cosmic rays have GeV energies, although some extremely energetic ones can exceed 10¹⁸ eV and therefore potentially generate millions of muons. The optimum concentration of the target material for the muon-catalyzed fusion may be determined experimentally based on the particular abundance of cosmic rays with a view to maintaining a chain reaction of fusion events for driving the electrical generating turbines.

Because both particle-target fusion and muon-catalyzed fusion, while recognized scientifically, are still experimentally immature technologies (since measurements have only been conducted to date on Earth using artificially accelerated particles and generated muons from particle accelerators), various embodiments of the present invention can have research utility to demonstrate feasibility in environments beyond Earth's protective atmosphere and/or geomagnetic field. First, a satellite platform in Earth orbit (for example, on the International Space Station) and then later a lander on the surface of the Moon are both conveniently close to Earth to place experimental modules in order to determine optimum parameters (e.g. dimensions of the chamber, and cloud density for different fuel types) in order to adequately drive the turbines.

What is claimed is:

1. A micro-fusion-driven turbine generator for producing electricity in the presence of ambient flux of cosmic rays and muons, comprising:
a source of deuterium-containing micro-fusion particle fuel material disposed on an asteroid surface;
a reaction volume directed upward from the asteroid surface;
a flue coupled to the source and reaction volume for dispersing fuel material into the reaction volume;
a set of helium-wind turbines arranged around the reaction volume, wherein cosmic rays and muons entering the volume from above interact with the dispersed fuel material to cause nuclear micro-fusion events, kinetic-energy containing micro-fusion products driving the helium-wind turbines; and
a set of electrical generators coupled to the respective helium-wind turbines to convert mechanical motion of the driven turbines into electricity.

2. The generator as in claim 1, further comprising an ion thruster powered by the generated electricity for producing thrust upon the asteroid in a specified direction.

3. The generator as in claim 1, wherein the reaction volume is a cylinder with an opening at an upper end to receive the cosmic rays and muons.

4. The generator as in claim 1, wherein the turbines are arranged radially around the circumference of the cylinder reaction volume.

5. The generator as in claim 1, wherein turbines are stacked vertically in multiple layers along a length of the cylinder reaction volume.

6. The generator as in claim 1, wherein one or more fans are provided in the reaction volume to maintain the dispersed fuel material in suspension within the reaction volume.

7. The generator as in claim 1, further comprising electrical power lines connecting the generators to one or more asteroid mining habitations.

8. The generator as in claim 1, wherein the deuterium-containing particle fuel material comprises Li⁶D.

9. The generator as in claim 1, wherein the deuterium-containing particle fuel material comprises D₂O.

10. The generator as in claim 1, wherein the deuterium-containing particle fuel material comprises D₂.

11. The generator as in claim 1, wherein the deuterium-containing particle fuel material is in solid powder form.

12. The generator as in claim 1, wherein the deuterium-containing particle fuel material is in pellet form.

13. The generator as in claim 1, wherein the deuterium-containing particle fuel material is in frozen form.

14. The generator as in claim 1, wherein the deuterium-containing particle fuel material is in liquid droplet form.

15. The generator as in claim 1, wherein the deuterium-containing particle fuel material also contain up to 20% by weight of added particles of fine sand or dust.
